(19) United States
(12) Patent Application Publication
(10) Pub. No.: US 2009/0159614 A1
(43) Pub. Date: Jun. 25, 2009

(54) FLUID DISPENSING SYSTEM

(76) Inventors: R. Bruce Yacko, Toledo, OH (US); Edward L. Mueller, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/394,986

(22) Filed: Feb. 27, 2009

Related U.S. Application Data
(63) Continuation-in-part of application No. 12/134,541, filed on Jun. 6, 2008.
(60) Provisional application No. 60/942,861, filed on Jun. 8, 2007.

(51) Int. Cl. B67D 5/56; B67D 5/60

(52) U.S. Cl. 222/129; 222/145.1

(57) ABSTRACT

A fluid dispensing system that provides storage means for at least one additional concentrate containing cartridge, the cartridge to be received by an open end of a fluid container and disposed on the outer surface thereof. The fluid dispensing system includes a fluid container, a fluid dispensing means, and a storage means for a concentrate containing cartridge.

### CROSS-REFERENCE TO RELATED APPLICATION

This application is a continuation-in-par of U.S. patent application Ser. No. 12/134,541, filed Jun. 6, 2008, and claims the benefit of U.S. Provisional Patent Application Ser. No. 60/942,861 filed on Jun. 8, 2007.

### FIELD OF THE INVENTION

The invention relates to fluid dispensing systems that include concentrate cartridges and a dispensing container for mixing fluid solutions and more particularly to dispensing containers that include means for storing a concentrate cartridge.

### BACKGROUND OF THE INVENTION

Component systems that require a consumer to assemble the system shortly before use have been found to be advantageous for particular uses, Examples of such systems include components incompatible with each other or include a component that is readily available to a consumer. Components of a fast acting epoxy, for example, are best suited for combination by a consumer shortly before use, due to their temporal nature, Alternately, a component which is readily available to consumers, like water, may be used to form solutions when mixed with a concentrate for use in a system.

Retailers of fluid dispensing systems have found it advantageous to carry multi-component products as well. Demand for individual components can easily be met by selling components separately. Water, when excluded from a fluid dispensing system, can drastically reduce the shipping weight of a product. A manufacturer who excludes water from a dispensing system may sell its products at a lower cost to consumers. Also, selling concentrate cartridges instead of whole systems requires significantly less retail shelf space, allowing a retailer to offer a greater variety of products or hold a larger inventory. Multi-component fluid dispensing systems enable retailers to reduce overhead costs and increase customer satisfaction.

Additionally, consumers of multi-component fluid dispensing systems have found it beneficial to purchase and use these products. A consumer may feel less wasteful when afforded the opportunity to reuse a dispensing container, reducing the amount of plastic in landfills. Purchasing a concentrate container instead of a pre-mixed solution in a dispensing container can save a consumer significant cost over time. Concentrate containers, which take up significantly less space than dispensing containers, and assure a consumer of a sufficient amount of working fluid to complete a task without having to store more than one container. Consumers benefit in many ways from incorporating multi-component fluid dispensing systems into their everyday lives.

Prior dispensing containers using concentrate containers have not provided a means of storage for a concentrate container. U.S. Pat. No. 6,041,969 discloses a multi-component fluid dispensing system that falls to provide a storage means for a concentrate container. Therefore, a user of the container must interrupt the task at hand to replace the concentrate container and fill the dispensing container with dilutant. A multi-component fluid dispensing system incorporating a storage means for one or more concentrate containers allows a user of the dispensing container to increase productivity.

It would be desirable to produce a dispensing container which would be typically maintained at the location of use with a storage means for holding at least one additional concentrate cartridge thereby militating against the user emptying the working fluid prior to completion of the task.

It is an object of the invention to produce a diluting dispensing container for receiving a concentrate containing cartridge wherein the container is provided with a storage means for at least one extra concentrate containing cartridge.

### SUMMARY OF THE INVENTION

Presently provided by the Invention, a diluting and dispensing container that provides at least one additional concentrate containing cartridge at the location of use, prolonging the use of the working fluid to increase productivity has surprisingly been discovered.

In one embodiment, the fluid dispensing system comprises a fluid container having a hollow interior defined by a closed bottom, an open end, and a sidewall having an outer surface and interconnecting the bottom and the open end, a fluid dispensing means attached to the open end of the container and adapted to receive a concentrate containing cartridge for introduction of a concentrate to the hollow interior of the container, and a storage means for selectively retaining at least one concentrate containing cartridge on the outer surface of the container.

In another embodiment, the fluid dispensing system comprises a fluid container having a hollow interior defined by a closed bottom, an open end, and a sidewall having an outer surface and interconnecting the bottom and the open end, a fluid dispensing means attached to the open end of the container and adapted to receive a concentrate containing cartridge for introduction of a concentrate to the hollow interior of the container, and a storage means for selectively retaining at least one concentrate containing cartridge on the outer surface of the sidewall of the container, wherein the storage means includes a compartment for receiving the concentrate containing cartridge.

In another embodiment, the fluid dispensing system comprises a fluid container having a hollow interior defined by a closed bottom, an open end, and a sidewall having an outer surface and interconnecting the bottom and the open end, a fluid dispensing means attached to the open end of the container and adapted to receive a concentrate containing cartridge for introduction of a concentrate to the hollow interior of the container, and a storage means for selectively retaining at least one concentrate containing cartridge on the outer surface of the sidewall of the container, wherein the storage means includes a cylindrical opening for removably receiving the concentrate containing cartridge.

### BRIEF DESCRIPTION OF THE DRAWINGS

The above, as well as other objects and advantages of the invention, will become readily apparent to those skilled in the art from reading the following detailed description of a preferred embodiment of the invention when considered in the light of the accompanying drawings in which:

FIG. 1 is an exploded perspective view of a fluid dispensing system incorporating the features of the Invention showing a fluid dispensing container having a storage means for a concentrate cartridge on the outer surface of the container;

FIG. 2 is a side elevation view of a fluid dispensing container incorporating the features of the invention showing a fluid dispensing container having a storage means for a concentrate cartridge in a closed position on the outer surface of the container;

FIG. 3 is a side elevation view of a fluid dispensing container incorporating the features of the invention showing a fluid dispensing container having a storage means for a concentrate cartridge in an open position on the outer surface of the container;

FIG. 4 is an exploded perspective view of a fluid dispensing system incorporating the features of another embodiment of the invention showing a fluid dispensing container having a storage means for a pair of concentrate cartridges on an outer surface of the container;

FIG. 5 is a side elevation view of a fluid dispensing container incorporating the features of the invention illustrated in FIG. 4; and

FIG. 6 is a top plan view of the storage means illustrated in FIGS. 4 and 5.

### DESCRIPTION OF THE PREFERRED EMBODIMENT

The following detailed description and appended drawings describe and illustrate an exemplary embodiment of the present invention. The description and drawings serve to enable one skilled in the art to make and use the invention, and are not intended to limit the scope of the invention in any manner. It is understood that materials other than those described can be used without departing from the scope and spirit of the invention.

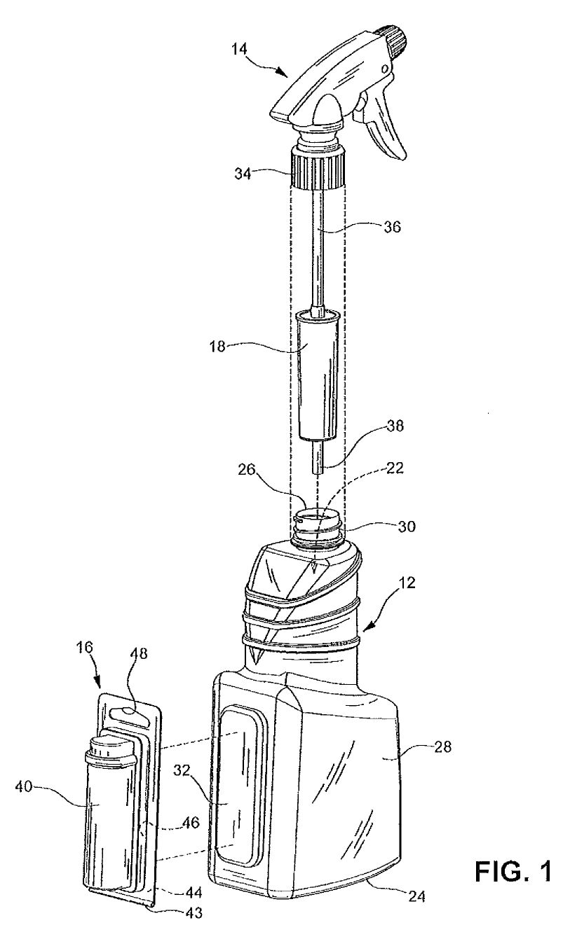

FIG. 1 shows an exploded perspective view of a fluid dispensing system according to an embodiment of the invention. The fluid dispensing system includes a diluting and dispensing container 12, a dispensing means 14, and a storage moans 16 for a concentrate cartridge 18. As shown, the diluting and dispensing container 12 has an outer surface, a hollow interior 22 defined by a closed bottom 24, an open top 26, and a sidewall 28 interconnecting the bottom 24 and the top 26. The dispensing container 12 may be formed from one of a plastic such as polyethylene terephthalate (PET) and high density polyethylene (HDPE), for example. When the container 12 is formed from polyethylene terephthalate, the container 12 can be manufactured through a two step process, including injection molding a quantity of PET into a desired shape which is subsequently blow molded to form the container 12. Alternately, when the container 12 is formed from HDPE a single blow molding process may be employed to form the container 12.

Attachment means, such as threads 30, may be integrally formed near the top 26 for the purpose of fastening the dispensing means 14 to the container 12. The container 12 includes a protuberance 32 integrally formed with the container 12 for retaining the storage means 16 by a press fit. Other methods may be employed to secure the storage means 16 to the dispensing container 12 such as adhesion, fusing, or the like; or alternatively, the storage means 16 may be formed integral therewith.

A fluid dispensing means 14 is attached to the open end 26 of the container 12. A closure cap 34 is rotatingly coupled to the dispensing means 14. The closure cap 34 includes internally formed threads on the inner surface of the closure cap 34 adapted to threadably engage with the threads 30 of the container 12. The fluid dispensing means 14 is provided with a dip tube 36, which is received by the container 12 and a concentrate containing cartridge 18. The dip tube 36 provides fluid communication between the hollow interior 22 of the container 12 and the dispensing means 14. The dispensing means 14 may be any conventional style of hand pump, and affords an operator of the fluid dispensing system a means to distribute a working fluid from the interior 22.

The concentrate containing cartridge 18 is adapted to be inserted into the open end 26 of the container 12. The cartridge 18 is provided with an annular shoulder adapted to rest against the upper surface of the top 26 and is adapted to be retained within the upper portion of the container 12. The dip tube 36 of the dispensing means 14 is inserted into and extends through the interior of the concentrate cartridge 18. The end 38 of the dip tube 36 is positioned adjacent the inner surface of the closed bottom 24 of the dispensing container 12, affording removal of the working fluid from the hollow interior 22.

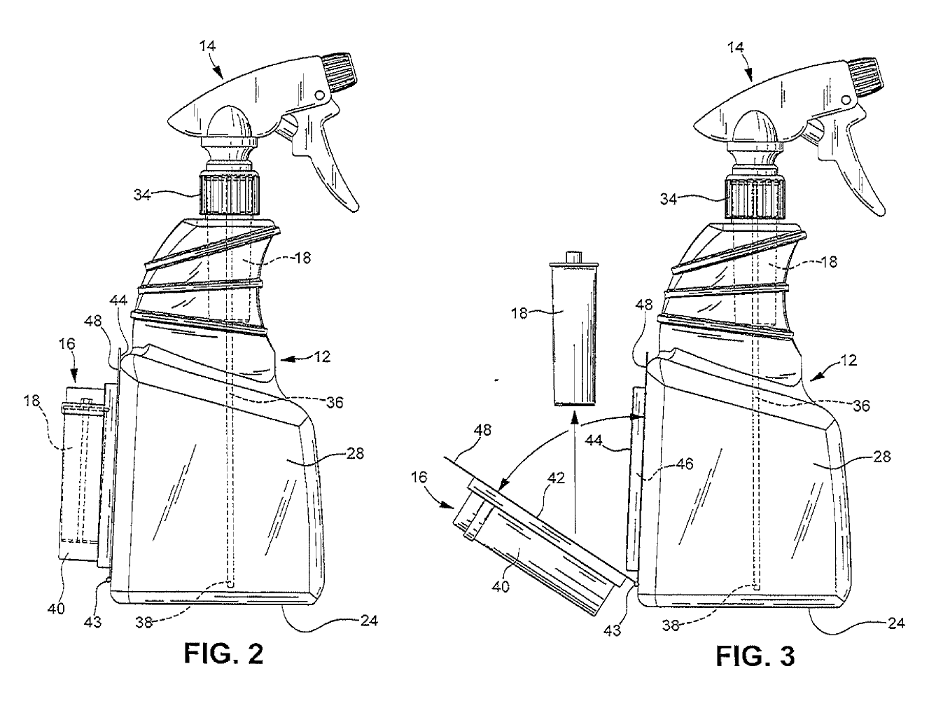

FIG. 2 is an elevational view of the dispensing means 14, concentrate cartridge 18, and dip tube 36 of the fluid dispensing system in assembled condition ready to be used by an operator.

The specifics of the operation and other structural features of the concentrate containing cartridge 18 are Illustrated and described in U.S. Pat. No. 6,290,100 which Is incorporated herein by reference.

As illustrated in the drawings, the storage means 16 for holding at least one additional concentrate cartridge 18 is included in the fluid dispensing system. The storage means 16 is preferably a single component typically formed by thermal forming a plastic such as PET, or any other suitable process. The storage means 16 includes a cartridge containing portion 40 having an opening 42 suitably conformed to receive a concentrate cartridge 18. It will be understood that the cartridge containing portion 40 may be configured to receive and contain more than one cartridge 18. However, for simplicity a single containing cartridge 18 is illustrated.

The cartridge containing portion 40 of the storage structure 16 is hingedly secured to an associated closure 44 by a living hinge 43. The closure 44 is provided with an exterior portion adapted to be press fitted within the opening 42. The closure 44 is provided with a section 46 which is adapted to receive the protuberance 32, affording a press fit to retain the structure 16 to the container 12. As portrayed in FIG. 3, the cartridge containing section 40 may be swung from a closed to an open position to provide ready access to the stored cartridge 18. After the cartridge 18 has been removed, the cartridge containing portion 40 may be swung into a closed position, as illustrated in FIG. 2, and secured by a press fit against the closure 44. Additionally, as illustrated in FIGS. 1 through 3, the cartridge portion 40 and closure 44 may contain apertures 48. The apertures 48 facilitate the display and storage of the structure 16.

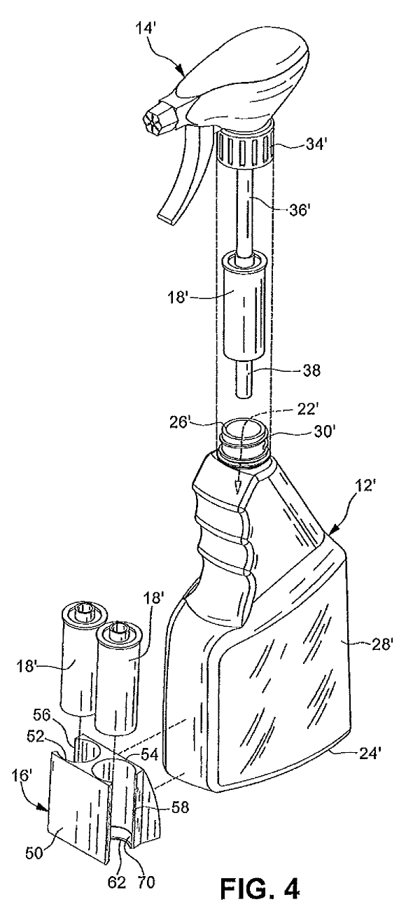

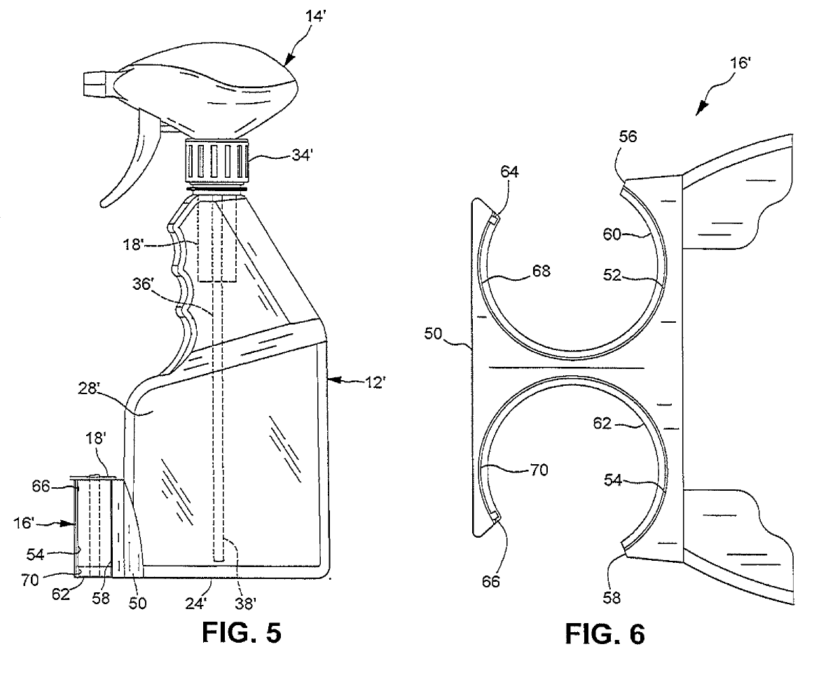

FIGS. 4-6 illustrate another embodiment of the invention, Structure similar to that Illustrated in FIGS. 1-3 includes the same reference numeral and a prime (′) symbol for clarity. In FIGS. 4-6, the storage means 16′ is adapted to removably hold two additional concentrate cartridges 18′ for the fluid dispensing system. The storage means 16′ shown is a single component typically formed by thermal forming a plastic such as PET, or any other suitable process or material. The storage means 16′ is attached to a side of the outer surface of the sidewall 28′ of the container 12′. It should be understood that the storage means can be attached to the container 12′ employing an adhesive or a welding process, for example.

The storage means 16′ includes a main body 50 having spaced apart generally cylindrically shaped openings 52, 54 extending therethrough. Each of the openings 52, 54 forms a compartment for removably receiving one of the concentrate cartridges 18′. Elongate slots 56, 58 are formed in the main body 50 along the axial length of the openings 52, 54 providing a passageway into the openings 52, 54. Radially inwardly extending lips 60, 62 are respectively are formed on a surface of the storage means 161 forming the openings 52, 64 adjacent one end thereof. The lips 60, 62 support the cartridges 18, removably received in the openings 52, 54. Protuberances 64, 66 are formed on the surface of the openings 52, 54 adjacent the slots 56, 58 to provide a frictional engagement with the cartridges 18′ to militate against an undesired removal of the cartridges 18′ from the openings 52, 54 during the use and storage of the fluid dispensing system. In the embodiment shown, the surface forming the openings 52, 54 include stepped portions 68, 70, respectively, to create a press-fit between the surfaces and the cartridges 18′ to militate against an undesired removal of the cartridges 18′ from the openings 52, 54 during the use and storage of the fluid dispensing system. It should be understood that the openings 52, 54 can have a tapered configuration to create the press-fit between the surfaces and the cartridges 18′

In use, a user of the dispensing system can place a finger and a thumb, for example, on opposing ends of the cartridge 18′. A force is applied to the cartridge 18′ to overcome the frictional engagement between the protuberances 64, 66 and the cartridge 18′ and remove the cartridge 18′ from the main body 50. The cartridge 18′ can be used to replace the cartridge 18′ already present in the open top 26′ of the container 12′.

From the foregoing description, one ordinarily skilled in the art can easily ascertain the essential characteristics of this invention and, without departing from the spirit and scope thereof, can make various changes and modifications to the invention to adapt it to various usages and conditions in accordance with the scope of the appended claims.

What is claimed is:

1. A fluid dispensing system comprising:
a fluid container having a hollow interior defined by a closed bottom, an open end, and a sidewall having an outer surface and Interconnecting the bottom and the open end;
a fluid dispensing means attached to the open end of the container and adapted to receive a concentrate containing cartridge for introduction of a concentrate to the hollow interior of the container; and
a storage means for selectively retaining at least one concentrate containing cartridge on the outer surface of the container.

2. The fluid dispensing system according to claim 1, wherein the storage means includes a compartment for receiving the concentrate containing cartridge.

3. The fluid dispensing system according to claim 2, further including a closure for the compartment of the storage means.

4. The fluid dispensing system according to claim 3, wherein the closure is hingedly mounted to the storage means.

5. The fluid dispensing system according to claim 1, wherein a frictional engagement is provided between the compartment and the concentrate containing cartridge.

6. The fluid dispensing system according to claim 1, wherein the storage means is selectively retained on the outer surface of the sidewall of the container.

7. The fluid dispensing system according to claim 6, wherein an elastic deformation of one of the fluid container and the storage means retains the storage means.

8. The fluid dispensing system according to claim 1, wherein the storage means is a single piece of thermally formed plastic.

9. The fluid dispensing system according to claim 1 wherein the storage means includes an aperture therein for one of storage and display of the storage means.

10. A fluid dispensing system comprising:
a fluid container having a hollow interior defined by a closed bottom, an open end, and a sidewall having an outer surface and interconnecting the bottom and the open end;
a fluid dispensing means attached to the open end of the container and adapted to receive a concentrate containing cartridge for introduction of a concentrate to the hollow interior of the container; and
a storage means for selectively retaining at least one concentrate containing cartridge on the outer surface of the sidewall of the container, wherein the storage means includes a compartment for receiving the concentrate containing cartridge.

11. The fluid dispensing system according to claim 9, further including a closure for the compartment of the storage means hingedly mounted to the storage means.

12. The fluid dispensing system according to claim 9, wherein the storage means is selectively retained on the outer surface of the sidewall of the container.

13. The fluid dispensing system according to claim 12, wherein an elastic deformation of one of the fluid container and the storage means retains the storage means.

14. The fluid dispensing system according to claim 9, wherein the storage means is a single piece of thermally formed plastic.

15. The fluid dispensing system according to claim 9, wherein the storage means includes an aperture therein for one of storage and display of the storage means.

16. A fluid dispensing system comprising:
a fluid container having a hollow interior defined by a closed bottom, an open end, and a sidewall having an outer surface and interconnecting the bottom and the open end;
a fluid dispensing means attached to the open end of the container and adapted to receive a concentrate containing cartridge for introduction of a concentrate to the hollow interior of the container; and
a storage means for selectively retaining at least one concentrate containing cartridge on the outer surface of the sidewall of the container, wherein the storage means includes a cylindrical opening for removably receiving the concentrate containing cartridge.

17. The fluid dispensing system according to claim 16, further including a lip extending outwardly from a surface of the opening in the storage means to support the concentrate containing cartridge removably received therein.

18. The fluid dispensing system according to claim 16, further including a protuberance extending outwardly from a surface of the opening in the storage means to provide a frictional engagement between the storage means and the concentrate containing cartridge removably received therein.

19. The fluid dispensing system according to claim 16, wherein the storage means is selectively retained on the outer surface of the container.

20. The fluid dispensing system according to claim 16, wherein the storage means is formed as a unitary structure from a thermally formed plastic.
